(19) United States
(12) Patent Application Publication
(10) Pub. No.: US 2016/0209195 A1
(43) Pub. Date: Jul. 21, 2016

(54) WEARABLE BLASTING SYSTEM APPARATUS

(71) Applicant: DETNET SOUTH AFRICA (PTY) LTD, Woodmead (ZA)

(72) Inventors: Michiel Jacobus KRUGER, Johannesburg (ZA); Craig Charles SCHLENTER, Sandton (ZA)

(21) Appl. No.: 14/912,437

(22) PCT Filed: Aug. 20, 2014
(86) PCT No.: PCT/ZA2014/000041

§ 371 Date: Feb. 17, 2016

(30) Foreign Application Priority Data
Aug. 20, 2013 (ZA) 2013/06246

(51) Int. Cl. F42D 1/055; G02B 27/01; G06F 3/0489; G06F 3/16; G06F 3/01; G06F 3/0488

(52) U.S. Cl. CPC F42D 1/055; G06F 3/012; G06F 3/013; G06F 3/04886; G06F 3/0489; G06F 3/167; G02B 27/0172; G02B 2027/014; G02B 2027/0141

(57) ABSTRACT

An apparatus for use with a detonator system which includes a user-wearable augmented display, a sensor system for sensing parameters related to the detonator system, a processor and a user-responsive interface, wherein the sensor system or the user-responsive interface outputs a sensor signal or a user signal, respectively, in response to which the processor generates an augmented image which is discernible to the user.

### BACKGROUND OF THE INVENTION

This invention relates generally to controlling implementation of a blasting system which includes a plurality of detonators.

Electronic blasting systems have evolved to embrace new technologies. Blasting system control devices which were previously constrained by available memory capacity and processing capability have been significantly enhanced. Despite these advances on the electronic front, certain fundamental aspects have not been altered. Thus, typically, an operator implementing a blasting system will use a handheld programming device with an embedded keyboard and a display screen for programming and testing electronic detonators in the blasting system.

A handheld device is prone to damage. Arduous conditions can exist at a blast site and such a device can easily be physically damaged if it is dropped: exposed to an explosive substance or the like. Another point is that a user normally holds the device in one hand and simultaneously clips a detonator to the device, or to a harness which is connected to the device, for programming purposes. The user must then verify information which is presented on the screen before continuing with the implementation of the blasting system.

A technique which has been suggested to improve the aforementioned process requires the use of a recognition system which allows an audible control signal relating to the blasting system (typically a voice message from an operator) to be processed. A widespread adoption of this approach is, however, constrained due to high noise levels which often prevail in a blasting environment.

Prior art related to the field of the invention, known to the applicant, includes the following: U.S. Pat. No. 7,650,841; U.S. Pat. No. 7,791,858; U.S. Pat. No. 6,644,202; U.S. Pat. No. 6,945,174; U.S. Pat. No. 7,156,023; EP0897098; U.S. Pat. No. 7,975,613; US2005/0283027; and WO2007/062487.

In U.S. Pat. No. 7,650,841 the blasting information of a detonator is determined using a handheld unit, U.S. Pat. No. 7,791,858 teaches the communication of at least two hardware components in a blasting system by means of a wireless link. U.S. Pat. No. 6,644,202 comprises a memory means for storing positional data and identity data pertaining to each detonator. There is provided a means for displaying this data and the time delay regarding each detonator.

U.S. Pat. No. 6,945,174 discloses a logging manager which is in contact with loggers and which ensures that, each detonator is connected correctly. The manager also receives data relating to each detonator. U.S. Pat. No. 7,156,023 teaches the use of a satellite-assisted navigation system to determine the geographical position of an ignition device. The information relating to the position is then conveyed to the logger.

U.S. Pat. No. 7,975,613 describes the use of an identity code, assigned to each detonator, to determine the geographical position of the detonator. US2005/0263027 provides for measuring the position of a detonator, in relation to the other detonators in a sequence, and using this information to calculate the initiation time of each detonator in the sequence.

WO2007/062467 infer alia describes transmitting data about each detonator through the use of voice control techniques. EP0897098 provides for the use of a combination of a GPS, to obtain positional data relating to a detonator, and an identity cods, assigned to each detonator, to provide data relating to each detonator via a data capturing device.

While these citations disclose user-discernible systems for providing information about a blasting system to a user with varying degrees of efficacy, they fail to cause an image, relevant to aspects of a blasting system, to be displayed to a user in a relevant and readily discernible manner.

An object of the present invention is to provide apparatus which simplifies the implementation of a blasting system and which is capable of providing information pertaining to aspects of the blasting system on an on-going and readily discernible manner to an operator.

### SUMMARY OF THE INVENTION

The invention provides, in the first instance, an apparatus for use with a detonator system which includes a plurality of detonators, the apparatus including a user-wearable augmented display, a sensor system which, upon detecting at least one defined parameter relating to the detonator system, outputs a respective sensor signal, a processor, and a user-responsive interface for inputting at least one user signal to the processor, and wherein the processor, in response to the at least one sensor signal or the at least one user signal, generates an augmented image related to at least one aspect of the detonator system, on the display which is discernible to the user.

It is convenient to provide the display so that it can be worn on a user's head. Different approaches can be used in this respect. The display may for example be of the type which is exemplified in the Google Glass™ mechanism. This mechanism is in the form of a pair of spectacles and is capable of projecting an image onto a retina of an eye of a user. Other approaches are however possible. For example a head-wearable display may be in the form of a helmet which contains a surface, displaced from the user's eyes, on which an image is visible.

The augmented image may be two-dimensional or three-dimensional. Any appropriate mechanism can be used for generating this image, in this respect use is preferably made of techniques which are known in the art and for this reason such techniques are not further described herein.

The display may be integrated with, or be compatible with, protective eyewear or protective headwear which may be prescribed by law or regulation to be worn by a user in or at a blasting environment.

The sensor system may include an array of appropriate sensors each of which is capable of detecting a respective defined parameter relating to the detonator system. For example one sensor may comprise or include a camera which can detect the presence of a borehole in which a detonator or detonators are located. Another sensor may function as a compass to give directional information to a user in respect of a given position in relation to the borehole system or a part thereof. Another sensor may provide location-dependent information. Often this information enables the geographical position of the sensor, and hence of the user wearing the display, to be determined with a high degree of accuracy. Another sensor may have a capability of reading data associated with a detonator. The data may be held in coded form e.g. in the form of a barcode on a detonator or on a component associated with the detonator. The sensor may be capable of reading this data and of producing a digital output thereof. A sensor may also be included which can receive, in wireless manner, information transmitted by a detonator or a component associated with the detonator, relating to aspects of the detonator such as its identity, timing data or the like. The scope of the information which can be transferred in this way to an appropriate sensor is not limited.

“Augmented image” in this specification refers to an image to which data or details, relating to particular parameters relevant to the detonator system, have been added.

The sensor system may include a detector which can estimate the height of a user, the positioning of the user's head and the orientation of the user's eyes. Positional and angular information of this kind is used to establish a relationship between the user and a borehole or a detonator and, in this way, a geographical position of the borehole can be determined more accurately.

The interface to the processor of the apparatus may acquire information or an input signal from a user directly or indirectly. For example the interface may include a device which is voice-sensitive and which is adapted to receive and respond to audible information which is input to the processor. A head gesture, e.g. a nodding or shaking of the user's head, can be detected by one or more accelerometers which are incorporated in the interface and which then provide related information to the processor. The interface may for example include a camera which detects eye movement or facial expressions of the user. This information can be used to convey commands or data to the processor. It is also possible for the interface to include push buttons, touch keys, an electronic keyboard or the like, whereby a user can input information to the processor.

The processor may, additionally, be responsive to signals which are transmitted to the processor from one or more external arrangements e.g. a tagger, a blasting machine, an external processor or the like. This allows the user to engage interactively with other devices and mechanisms used in or with the blasting system.

The processor may, additionally, be capable of communicating with a similar processor of another apparatus of the kind referred to. For example a first user who has a user-wearable augmented display of the kind referred to may be responsible for overseeing a defined part of a detonator system, A second user with similar apparatus may oversee the implementation of a different part of the detonator system. It is possible for the respective processors to communicate with each other so that each user obtains a more complete image, on a respective display, of aspects dealing with, possibly, the entire detonator system.

The invention extends, in the second instance, to a device which comprises a user-wearable tagger for reading information from, or for transmitting information to, a detonator in the detonator system.

The information which is transmitted to or by a detonator may include identity data relating to the detonator, test instructions, the results of tests conducted by or on a detonator e.g. data relating to integrity aspects of the detonator, information relating to aspects of the detonator status, calibration data, timing data and the like. The invention is not restricted in this respect.

The tagger may include a transmitter for transmitting data, preferably wirelessly, to an external processor. Conversely the tagger may include a receiver for receiving data, preferably by wireless means, from an external source.

The tagger may be worn at any appropriate position on a user's body. For convenience it is preferred for the tagger to be worn on a wrist of a user.

The tagger may include a mechanism which is capable of generating and outputting information relating to the position of the tagger and of the user.

According to another aspect of the invention there is provided a portable mechanism which includes a wireless communication facility, a memory unit for data storage, a processor, and a generator which can generate or access positional information relating to the position of the processor or of the mechanism.

The mechanism may be custom-designed, or a smart phone, loaded with suitable application software, may be employed for this purpose.

The mechanism may, in use, receive data from the aforementioned apparatus and from the aforementioned device and output data and information to the apparatus or to the device.

The mechanism may be one of a number of similar mechanisms used in the blasting system and the mechanisms may be capable of communicating with one another.

The invention also extends to a blasting system which includes a blasting machine, a plurality of detonators which are responsive to signals from the blasting machine, apparatus of the aforementioned kind associated with a user, a device of the aforementioned kind associated with the user and a processing mechanism of the aforementioned kind, and wherein, when the user is at a detonator, data on the detonator is input to or output by, at least one of the apparatus, the device or the mechanism, and an augmented image relating to the data is generated on the display.

In one form of the invention the tagger reads the identity of the detonator and implements a test process for the detonator. The results of the test process are relayed to the mechanism which records the identity of the detonator and the test results. Information thereon is transmitted by the mechanism to the apparatus and the processor of the apparatus, in response thereto, generates an image, on the display, which is based on, or related to, such information.

The user may be audibly notified by the apparatus of an event e.g. the generation of the image.

According to a different aspect of the invention there is provided apparatus for use with a detonator system which includes a plurality of detonators, the apparatus including a user-wearable augmented display, at least one detector for detecting a defined parameter relating to the detonator system, a tagger which outputs information relating to respective detonators and a processor which, in response to the detector and the information from the tagger generates an augmented image, relating to the detonator system, on the display.

### BRIEF DESCRIPTION OF THE DRAWINGS

The invention is further described by way of example with reference to the accompanying drawings in which:

FIG. 1 is a schematic representation of a blasting system,

FIG. 2 is a block diagram representation of apparatus according to the invention,

FIG. 3 is a block diagram representation of a device according to the invention,

FIG. 4 is a block diagram representation of a mechanism according to the invention,

FIGS. 5 and 6 are diagrams depicting distance and angular information usable in Implementing aspects of the invention,

FIG. 7 illustrates in diagram form various functional aspects associated with the apparatus of FIG. 2, the device of FIG. 3, and the mechanism of FIG. 4, respectively, and

FIG. 8 illustrates a head wearable display in the form of a specially-designed helmet for use in the invention.

### DESCRIPTION OF PREFERRED EMBODIMENT

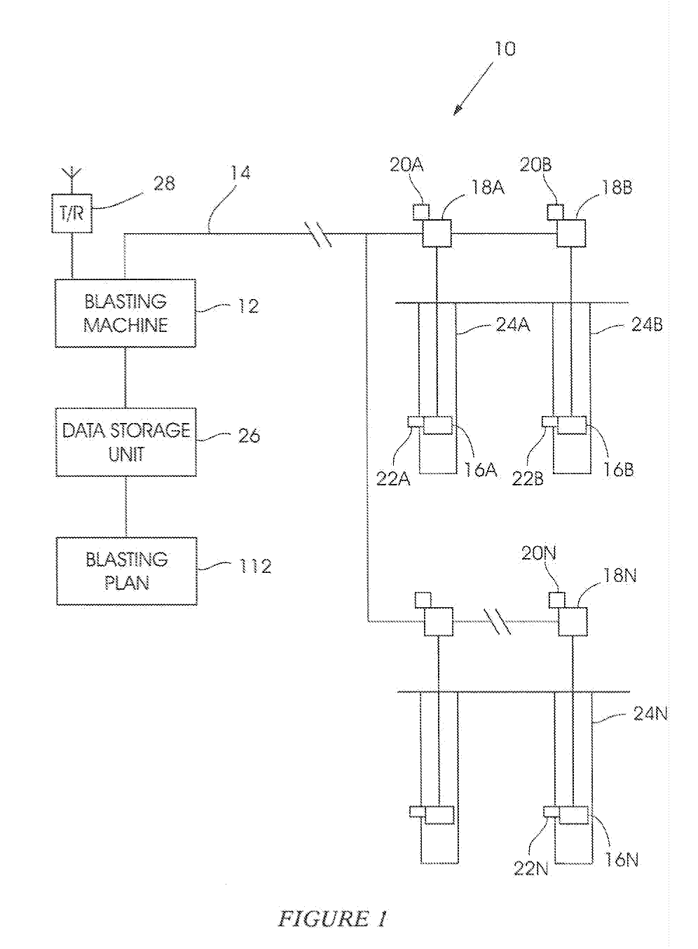

FIG. 1 of the accompanying drawings illustrates a blasting system 10 which includes a blasting machine 12 of any appropriate type, a harness 14, and a plurality of detonators 16A, 16B . . . 16N which are respectively connected to the harness by connectors 18A, 18B . . . 18N. Each connector may carry a respective emblem e.g. on an associated tag 20A . . . 20N which represents a barcode or other identity data pertaining to the connector and hence to the corresponding detonator. Alternatively this

information could be carried on an emblem or tag 22A . . . 22N associated with the

detonator. The latter possibility is less preferable though because, in use, each detonator is placed in a respective borehole 24A . . . 24N, and the corresponding emblem is then not easily visually discernible.

The blasting system illustrates the use of a harness between the blasting machine and the detonators. This however is exemplary and non-limiting. The principles of the invention can be used with equal effect in a wireless system wherein control of the detonators is exercised by the blasting machine using signals which are transmitted wirelessly e.g. by means of magnetic principles.

The blasting machine includes a data storage unit 26, and an internal processor, not shown, and is linked to, or includes or is otherwise associated with, a transmitter and receiver 28.

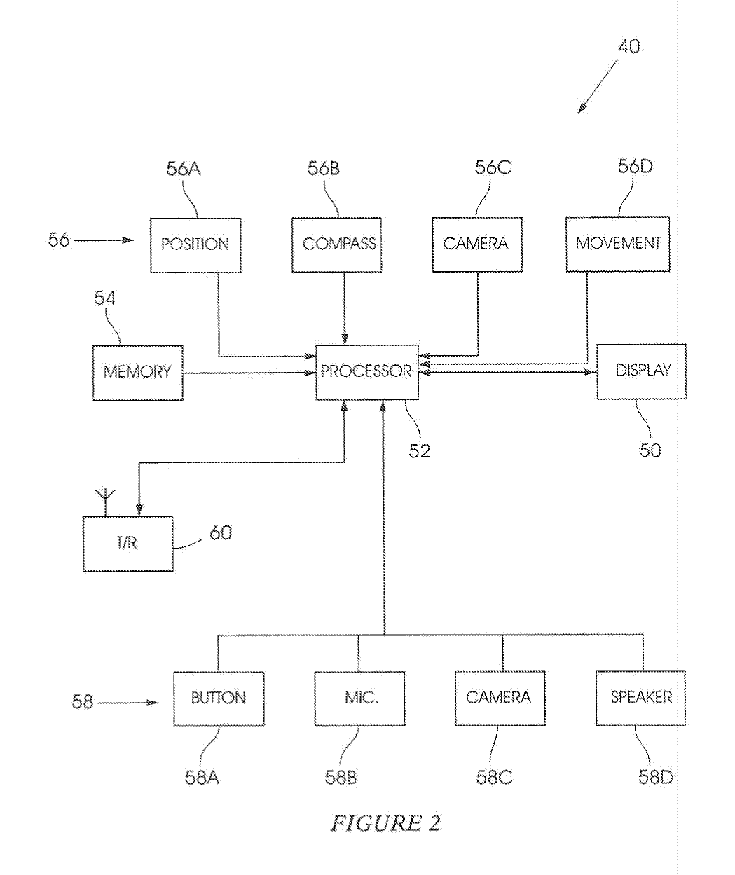

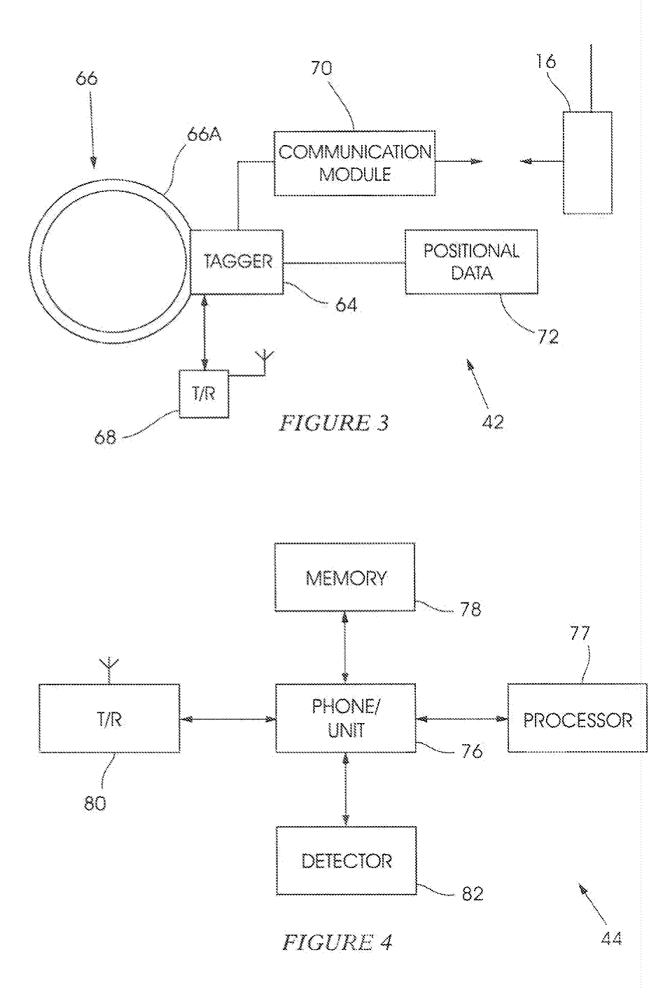

In implementing the inventive principles of the current invention use is made of apparatus 40, schematically depicted in FIG. 2, optionally of a device 42 shown schematically in FIG. 3 and, optionally, of a mechanism 44 shown schematically in FIG. 4.

A principal element of the apparatus 40 is a user-wearable augmented display 50 exemplified by, but not limited to, a display of the type known as Google Glass™. This is provided in the form of a pair of spectacles and contains an inbuilt processor 52 at a suitable location. A projecting device is adapted to project an image generated by the processor onto a retina of an eye of the user. Other display techniques and devices may however be used. For example the user may be given headwear 50A (see FIG. 8) which contains a screen 50B which is presented to the users eyes on which information is projected, much in the manner of a heads-up display for a pilot, or of the kind which is used in certain motor vehicles. The headgear includes a plurality of sensors 50X which are generally of the nature described hereinafter. Optionally the headgear includes earphones 50E and a microphone which allow for verbal communication to take place between users. These types of devices provide a see-through capability but nonetheless are capable of displaying images which are discernible by a user.

The image projected by the display 50 is an augmented image to which data, which may be in any suitable form, graphic or pictorial, relating to the detonator system has been added.

The processor 52 is connected to a memory unit 54, to a plurality of sensors 56, and to an interface structure 58.

The sensors 56 vary according to requirement, in this example the sensors include a sensor 56A which can generate positional information detailing the position of the sensor and hence of the apparatus 40, an electronic compass 56B which generates directional information, a camera 56C which is coupled to image recognition software (in the camera or in the processor) and which produces data on visual information, and a sensor 56D which is responsive to rapid, particular, head movement.

The interface structure 58 includes a plurality of touch-dependent buttons or contact devices 58A, a microphone 58B, a camera 58C and a loudspeaker or other audio output device 58D. In this context “audio output device” includes a mechanism which can convey audio content to a user, for example by transmitting sound signals, or signals to an ear or other body part e.g. bone structure of the user. The processor 52 is connected to a transmitter/receiver unit 60.

The device 42 (FIG. 3) embodies a tagger 64 which exhibits functions typically displayed by existing taggers. However the tagger 64 is associated with structure 66 which allows the tagger to be worn by a user at a suitable body location. A preferred arrangement is one in which the structure 66 comprises a wristband 66A which carries the tagger. The tagger preferably has a transmitting and receiving unit 68, a communication module 70 for interacting with a detonator 16, and a module 72 which can determine positional data.

The mechanism 44 (FIG. 4) comprises a unit 76 which is custom-designed or, alternatively, use is made of a smart phone which is loaded with application software developed for the purpose. The unit 76 has a processor 77, a memory facility 78 and a transmitter/receiver module 80. Preferably the unit 76 includes a detector or generator 82 which detects and generates positional data.

It is possible for the mechanism 44 to be a separate device or to be integrated; or otherwise associated with the apparatus 40 or with the tagger device 42. The tagger could, similarly, be associated with the apparatus 40.

The apparatus 40, the device 42 and the mechanism 44 are capable of communicating with each other, preferably wirelessly, as required. Different technologies may be used for this purpose such as low energy Blue Tooth or 802.11 variants.

Referring to the detonator system 10 shown in FIG. 1 a primary task is to associate a correct blasting time with each detonator 16. This task may be performed directly in that a blasting time is loaded into a memory of the detonator, typically when the detonator is placed into a blast hole 24. Later the detonator may be instructed to fire at the chosen time, possibly after a calibration exercise has been completed and a test routine has been carried out to ensure that all detonators are present and are responding appropriately.

In an alternative approach a blasting time is associated in an indirect manner with each respective detonator. In this case, the identity of each detonator is recorded together with the blasting time. Alternatively, the detonators identity is recorded with the detonator's position data. In the latter case the position data is used to determine the firing time in accordance with a desired blasting protocol. The firing time and the detonator identity are used to program the detonator before firing.

In each approach the detonator is assigned an identity, e.g. a number or code, under factory conditions or in the field. The identity may be read electronically from the detonator or from an associated electronic tag or a label (e.g. the tag 20 or 22) associated with the detonator, or a suitable chosen identity may be written into the detonator's memory.

The apparatus 40, the device 42 and the mechanism 44 are used to execute the aforementioned steps as follows. Assume, for example, that for each detonator its identity is to be read electronically from the detonator.

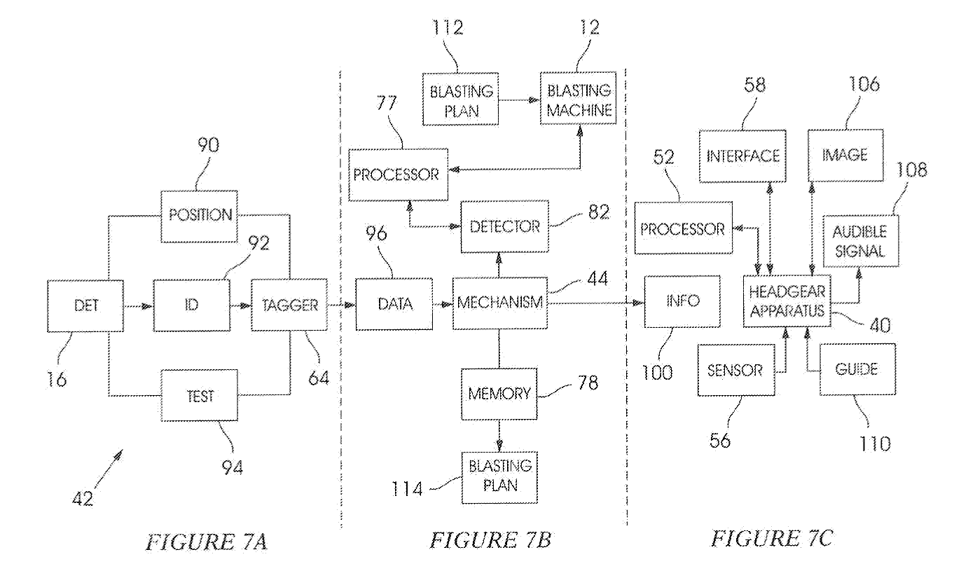

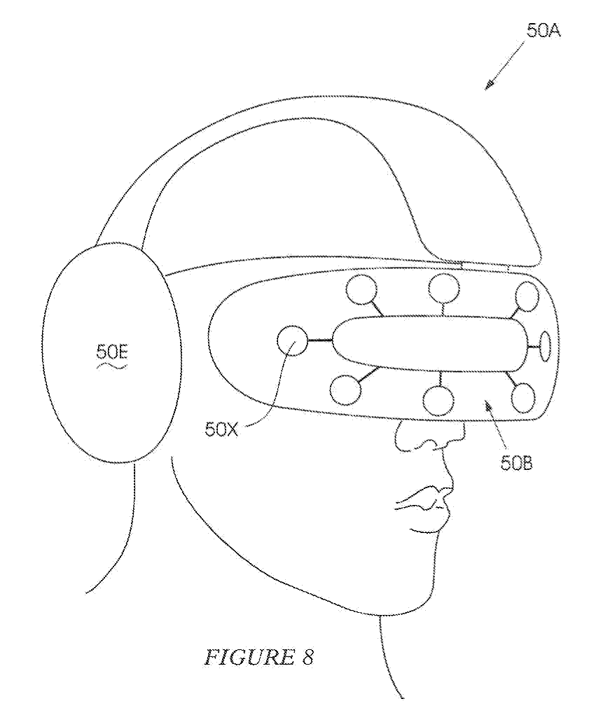

Reference is made in this respect to the various aspects shown in an exemplary manner in FIG. 7.

A user has the tagger 64 strapped to his wrist. The user operates the tagger 64 to allow the module 72 to read the position 90, and to read the identity 92, of one of the detonators 16, and also initiates a test routine 94 which is executed by the detonator. The results of the routine 94 are transmitted to arid received by the tagger (FIG. 7A). Subsequently, automatically or under the control of the operator, data 96 pertaining to the test results (94) and the detonator identity (92) are transmitted from the tagger 64 to the mechanism 44 and then stored in the memory facility 78 (FIG. 7B).

Pertinent information 100 is transmitted from the mechanism 44 to the headgear 40 (FIG. 7G). The processor 52 associated with the headgear 40, using a proprietary algorithm, processes the data and generates an augmented image 106 reflecting the detonator's identity and the outcome of the test routine. In any appropriate manner, on the display 50. Optionally, an audible signal 108 is generated by the processor and presented to the operator wearing the apparatus via the loudspeaker 62.

The image may be displayed for a limited period or until the user inputs a signal to the processor to dismiss the display's image.

The user is capable of interacting with the processor using the interface structure 58. For example, a touch key 58A may be used by the operator for this purpose. Another possibility is for a command to be spoken by the operator—this is accepted by the microphone 58B, translated, and input to the processor. The camera 58C may also be adapted for this purpose. If may for example monitor facial or eye expressions and convert this into corresponding signals using appropriate software routines.

Yet another possibility is for the sensor 56D to be used to input a command to the processor. This device includes at least one accelerometer which can respond to head movements e.g. nodding or shaking and, in this way, wireless control over the processor may be exercised at least to a limited extent.

The mechanism 44 includes the detector 82 which can determine positional data. Such data is recorded periodically in the memory facility 78. Alternatively positional data 90 is recorded (via the tagger) each time a detonator 16 is coupled to the tagger 64. This data is a reasonable approximation of the true detonator position in the corresponding borehole 24. In this event, the positional data 90 is relayed, as appropriate, to the mechanism 44 and stored in the facility 78. The latter approach may be preferred in that the positional data generated by the tagger is usually more accurate than the positional data determined by the detector module 82. For example, if the tagger is attached to a user's wrist the tagger position would normally be closer to a borehole than the detector 82, during a tagging process.

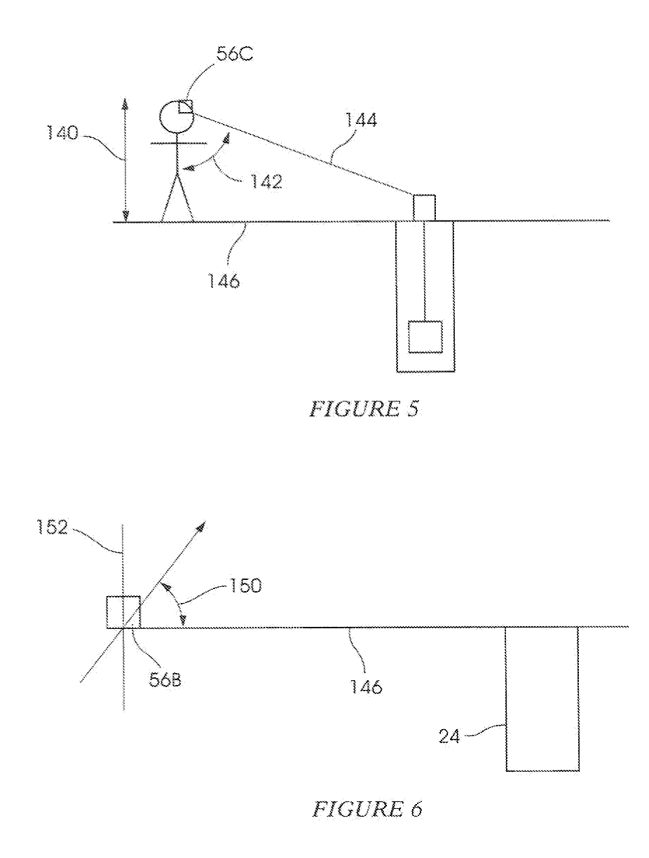

Another approach is to make use of the positional sensor 56A in the apparatus 40 (FIG. 2). This sensor accurately determines the position of the user. If, at that time, the camera sensor 56C is used and is aligned by appropriate head movement of the user with the position of the borehole, then an accurate determination of the true borehole position can be made. In this respect reference is made to FIG. 5 and FIG. 6. FIG. 5 shows a camera sensor 56C mounted to the user's head. This is at a height 140, above the ground, which is measured or known. A measurement is made of the angular inclination 142 of the line of sight 144 of the camera to the borehole 24 and a base distance 146 between the user and the borehole can be determined. If the directional compass 56B is used, as shown in FIG. 6, then the angular inclination 150 of the base distance 146 to a reference line 152 can be ascertained. The information generated using the approach shown in FIGS. 5 and 6 can be used to adjust the positional information obtained from the sensor 56A and a more accurate determination of the position of the borehole 24 is achieved.

In general, when determining the position of the borehole, irrespective of which approach or approaches are used, correctional data may be utilized to make the positional information more accurate. For example, differential GPS correction data may be obtained from a suitable source and applied, as appropriate, to the positional information which has been generated by the tagger or by the detector 82 to obtain positional data which is more accurate.

The processor 77 of the mechanism 44 is able to communicate, preferably wirelessly, with the blasting machine 12. In this way a blasting plan 112 or information thereon may be transferred via the blasting machine to the processor 77, An alternative approach is to store the required information in this respect beforehand in the memory facility 78 and make it available to the processor as required. This information may, for example, deal with the firing time of each detonator, the hole number or location of a detonator or the like. The information, as appropriate, may be transformed into an image, presented on the display 50, or relayed to a user audibly, or both approaches may be adopted. The user may be alerted to a discrepancy between planned and actual hole locations. Detonator timing may be adjusted manually or automatically as required to compensate for discrepancies or to accommodate user preferences. Alternatively information such as the actual hole position, detonator identity number and timing information may be recorded for later use in establishing an appropriate blasting plan.

An important aspect of the invention is the capability offered by the display 50 to present an augmented image 106 which augments what is visually directly discernible. For example a user may directly see a borehole or a detonator and, through the use of the hardware and software associated with the apparatus 40, the device 42 and the mechanism 44, images relating to the borehole or detonator are superimposed on the true (physical) picture. Timing information and detonator identify numbers can be shown, in the image, adjacent the borehole, if the field of the user's vision is altered, for example if the user looks at an adjacent borehole, then the data pertaining to that borehole is shown, instead, superimposed on the actual view.

This technique holds further benefits in that a user going to a borehole can then immediately be given visual information (106), assisted as appropriate by audible information (108), which indicates operational steps which have already taken place at that borehole. Thus the user may be notified that the detonator has been fully tested and that timing data has been transferred to the detonator in the borehole. The user may be prompted by audible or visual commands to go to a borehole at which operational aspects have not yet been concluded. Conveniently an operator may be guided (110) by prompts, via the mechanism 44 to traverse or visit the boreholes in the blasting system in an effective way. For example the processor 77 may use a blast plan 114 resident in the memory facility 78 or derived from the blasting machine 112 and generate a set of signals and instructions to an operator so that the blasting site is covered in an efficient manner.

Information which is displayed can be presented in different colours to highlight different attributes of the blasting system. Other visual cues can be used, for example, to distinguish holes that have been primed with detonators to those which have not been primed. The invention has little restriction in this regard.

Thus the user may request that the apparatus is placed into a mode in which the user is guided to a specific hole by appropriate visual or audible cues based on a requested hole identity and the user's current location.

In a large blasting system, one which employs hundreds or even thousands of detonators, a number of operators may be required to implement the blasting system. Each operator may then have a respective set of the equipment shown in FIGS. 2, 3 and 4. Via the respective mechanisms 44 which are carried by the different operators information from each operator can be transmitted to a centralised location, say at the blasting machine 12, and at this location the information is consolidated. In this way information pertaining to an operator's activities and functional area is available to each other operator. Consolidated information detailing the total number of holes or detonators completed in the blasting system and identifying those holes which have not yet been primed, is then available at each detonator. Also, the activities of each operator, and the priming of each borehole and detonator, can be recorded.

If multiple detonators are to be placed in a single borehole it is often necessary to determine the vertical position of each detonator as this can affect timing aspects. This information can be obtained directly from a label or tag 22A on the detonator which is related to the length of wire between the connector 18 and the detonator. The user may alternatively provide this information in an appropriate way by means of a voice command, a touch command or the like. An operator may also choose to work in a specific pattern, for example a detonator which is the first detonator to be placed in a hole may have the greatest vertical depth and the equipment may rely on this, in the absence of other input from the operator, to determine the position of the detonator in the borehole.

In a situation in which an identity number is to be assigned to each detonator the identity number may be determined by the mechanism 44 or by the device 42, in each instance possibly through using an appropriate algorithm. Another approach is to assign the identity numbers sequentially or by using information such as the location or identity of the operator, information pertaining to the blast site, and so on, to generate an identity number. It is also possible to assign an identify number to a detonator using information retrieved from a predetermined blasting plan.

In the system shown in FIG. 1 use is made of the harness 14 to connect the blasting machine to the detonator 16. If this is the ease then use of the device 42 can, possibly, be avoided. This however requires that the blasting machine 12 must have the capability to detect each detonator as it is connected to the harness. This information can be relayed to the operator directly and the apparatus 40 then uses and processes that information as if it had originated from a device 42.

The equipment of FIGS. 2, 3 and 4 can be used interactively to allow an operator to control the blasting machine 12. Voice recognition or other appropriate authentication procedures may be required to confirm the authenticity of control procedures. The operator carrying the headgear 40, via the camera 58C, can continuously capture images in the user's field of vision or in response to a request from the operator An image recognition algorithm could be employed in the processor 52 or in the processor 77 to ascertain whether an image contains an embedded barcode or other readable identity number and, in this event, the relevant data is recorded together with the operator's location. Appropriate feedback is given to the operator upon recognition of the label e.g. the label boundary may be augmented with appropriate visual cues such as a highlighted visual boundary around the label displayed to the operator. If this technique is adopted then a requirement for the device 42 is eliminated.

Without being restrictive the image presented on the display could include data pertaining to the identity number, firing time and location, of a detonator. This may be presented during, or subsequent to, a tagging exercise. The image in the display may be configured to identity specific or target boreholes at which the presence of an operator is required or at which specific tasks are to be undertaken. The image may also distinguish detonators which are tagged, from detonators which have not yet been tagged, A map of all or part of the blasting system, including factors pertaining to the design of the blasting system, can be embodied in an image to assist an operator to find, and assign firing times to, respective detonators.

An operator may employ, as an input interface device, a camera which can be used in a variety of ways. For example a visual survey can be undertaken, in addition to other precautions, to ensure that an area occupied by the blasting system, i.e. the bench, is unoccupied prior to firing.

The input structure tends itself to an arrangement wherein commands and instructions can be input to the blasting system, i.e. particularly to the processor 77, in a much simplified manner. In a high noise environment specific hand gestures, facial gestures, eye movements, and head movements can be used to send commands to the processor 77. Another capability is to implement the assignment of a time delay to the detonator by eye action, for example, alone. An operator could visually focus on an image or images of a plurality of time delays presented on the display 50, and then visually “drag” a selected time delay to an identity number of a target detonator.

1. An apparatus for use with a detonator system which includes a plurality of detonators, the apparatus comprising a user-wearable augmented display, a sensor system which, upon detecting at least one defined parameter relating to the detonator system, outputs a respective sensor signal, a processor, and a user-responsive interface for inputting at least one user signal to the processor, and wherein the processor in response to the at least one sensor signal or the at least one user signal, generates an image, related to at least one aspect of the detonator system, on the display, which is visually directly discernible to the user and which is augmented by the addition of data or parameters, in graphic or pictorial form, relating to the detonator system.

2. An apparatus according to claim 1 wherein the display is configured to be worn on a user's head.

3. An apparatus according to claim 2 wherein the display is in the form of one of (i) a pair of spectacles on which the image is visible, and (ii) a helmet which contains a surface, displaced from the user's eyes, on which the image is visible.

4. An apparatus according to any one of claims 1 to 3 wherein the image is one of (i) a two-dimensional image, and (ii) a three-dimensional image.

5. An apparatus according to any one of claims 1 to 3 wherein the display is included in one of (i) protective eyewear and (ii) protective headwear.

6. An apparatus according to any one of claims 1 to 3 wherein the sensor system includes an array of sensors each of which is capable of detecting a respective defined parameter relating to the detonator system.

7. An apparatus according to claim 6 wherein the array of sensors includes at least one of the following: a sensor which provides positional information, a camera, an electronic compass, and a sensor which is responsive to movement.

8. An apparatus according to any one of claims 1 to 3 wherein the sensor system includes a detector which is configured to estimate the height of a user, the positioning of a user's head and the orientation of a user's eyes.

9. An apparatus according to any one of claims 1 to 3 wherein the interface includes at least one of the following: touch dependent buttons or contact devices, a microphone, and a keyboard.

10. An apparatus according to any one of claims 1 to 3 wherein the processor is responsive to signals which are transmitted to the processor from at least one of the following: a tagger, a blasting machine, and an external processor.

11. An apparatus according to any one of claims 1 to 3 wherein the processor is capable of communicating with a similar processor of another apparatus according to claim 1.

12. A device for use with the apparatus of any one of claims 1 to 3 which comprises a user-wearable tagger for reading information from, or for transmitting information to, a detonator in the detonator system, and wherein at least part of such information is included in the augmented image.

13. A device according to claim 12 wherein the information includes at least one of the following: identity data relating to a detonator, test instructions, results of tests conducted by or on a detonator, information relating to aspects of a detonator's status, calibration data and timing data.

14. A device according to claim 12 wherein the tagger includes a transmitter for transmitting data to an external processor.

15. A device according to claim 12 wherein the tagger includes a receiver for receiving data.

16. A device according to claim 12 wherein, in use, the tagger is worn on a user's body.

17. A device according to claim 12 wherein the tagger is configured to generate information relating to the position of the tagger and of the user.

18. A portable mechanism for use with the apparatus of any one of claims 1 to 3 which includes a wireless communication facility, a memory unit for data storage, a processor, and a generator which provides information relating to the position of the mechanism, and wherein at least part of such information is included in the augmented image.

19. A portable mechanism according to claim 18 which comprises a smart phone loaded with suitable application software.

20. A portable mechanism according to claim 18 which is configured to receive data from the apparatus and to output data to the apparatus.

21. A blasting system which includes a blasting machine, a plurality of detonators which are responsive to signals from the blasting machine, apparatus according to claim 1 associated with a user, a device which comprises a user-wearable tagger for reading information from, or for transmitting information to, a detonator in the detonator system, wherein at least part of such information is included in the augmented image, and the information includes at least one of the following: identity data relating to a detonator, test instructions, results of tests conducted by or on a detonator, information relating to aspects of a detonator's status, calibration data and timing data, the device being associated with the user, and a portable processing mechanism for use with the apparatus which includes a wireless communication facility, a memory unit for data storage, a processor,-and a generator which provides information relating to the position of the mechanism, and wherein at least part of such information is included in the augmented image and data on a detonator of the plurality of detonators is input to or output by, at least one of the apparatus, the device or the mechanism, and the augmented image relating to the data is generated on the display.

22. An apparatus for use with a detonator system which includes a plurality of detonators, the apparatus including a user-wearable display, at least one detector for detecting a defined parameter relating to the detonator system, a tagger which outputs information relating to respective detonators and a processor which, in response to the detector and the information from the tagger, generates an image, relating to the detonator system, on the display, which image comprises an image of at least a part of the detonator system which is visually directly discernible to the user and which is augmented by the addition of data or parameters, in graphic or pictorial form, relating to the detonator system.

23. A portable mechanism which includes a wireless communication facility, a memory unit for data storage, a processor, and a generator which can generate or access positional information relating to the position of the processor or of the mechanism wherein the processor, utilising said positional information and data from the memory unit, produces a signal which is transmitted by the communication facility to augment an image on a display, wherein the image comprises an image of an aspect of a detonator system which is visually directly discernible, and wherein this image is augmented by the addition of data or parameters, in graphic or pictorial form, relating to the detonator system.

24. (canceled)
